(19) United States
(12) Patent Application Publication
(10) Pub. No.: US 2011/0030156 A1
(43) Pub. Date: Feb. 10, 2011

(54) Cleaning brush for motorcycles

(76) Inventor: Luc Pellerin, Deux-Montagnes (CA)

Correspondence Address: Luc Pellerin, # 106, 3591 Gouin E., Montreal, QC, H1H 5V7, CA

(21) Appl. No.: 12/688,248

(22) Filed: Jan. 15, 2010

(30) Foreign Application Priority Data
Aug. 4, 2009 (GB) GB091356.4

(51) Int. Cl. B60S 3/00

(52) U.S. Cl. 15/53.1

(57) ABSTRACT

A cleaning brush for motorcycles has a hose connector; a water shut off knob; a handle; a core through which water passes; holes along the core so that water can exit; and bristles that are attached and extend from the core.

This application claims priority based on Request GB0913567.4 filed Aug. 4, 2009

### FIELD OF THE INVENTION

The present invention relates generally to cleaning implements but more particularly to a cleaning brush for motorcycles.

### BACKGROUND OF THE INVENTION

There are many types of brushes out there but there are also many things that need to be cleaned and therefore there is always a need for a more specialized type of cleaning brush, especially for the tiny nooks and crannies of certain objects like motorcycles for example.

### SUMMARY OF THE INVENTION

It is a main advantage of this invention to provide for a brush designed to scrub and clean areas that are hard to reach on a motorcycle.

To attain these ends, the present invention generally comprises a brush that has an elongated hollow core member adapted to allow water to pass therethrough, the core member including holes adapted to allow the water to pass therethrough and out from the hollow core member. A hose connector member located at a primary distal end of the core member, the hose connector member adapted to securely and removably connect to a hose member; a water shut-off valve member located upon the core member and adjacent the hose connector member, the water shut-off valve member adapted to block the flow of water through the core member when desired. A handle member located adjacent the water shut-off valve, the handle member adapted and shaped to increase the ease of handling the cleaning brush. Bristle members attached to an outer surface of the core member opposite the primary distal end, such that water can pass through the holes in the core member and onto, between, and through the bristles allowing the brush to be used to clean a motorcycle in a continuous and effective manner.

In a preferred embodiment, the core member is cylindrical. Also, the core member can be adjustable in length by way of two telescoping members and is therefore capable of protracting and retracting.

In another preferred embodiment, the cleaning brush has a core member that is bendable along one axis.

In still another preferred embodiment, the water shut-off valve member includes a rotatable handle member, such that water can be blocked from passing through the core member by rotating the handle.

A combination of a motorcycle and a cleaning brush, wherein the motorcycle has a connector member adapted to hold and store the cleaning brush when not in use. The cleaning brush, in such a combination, being as described hereinabove.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIG. 1 Side view of the invention in context of use.

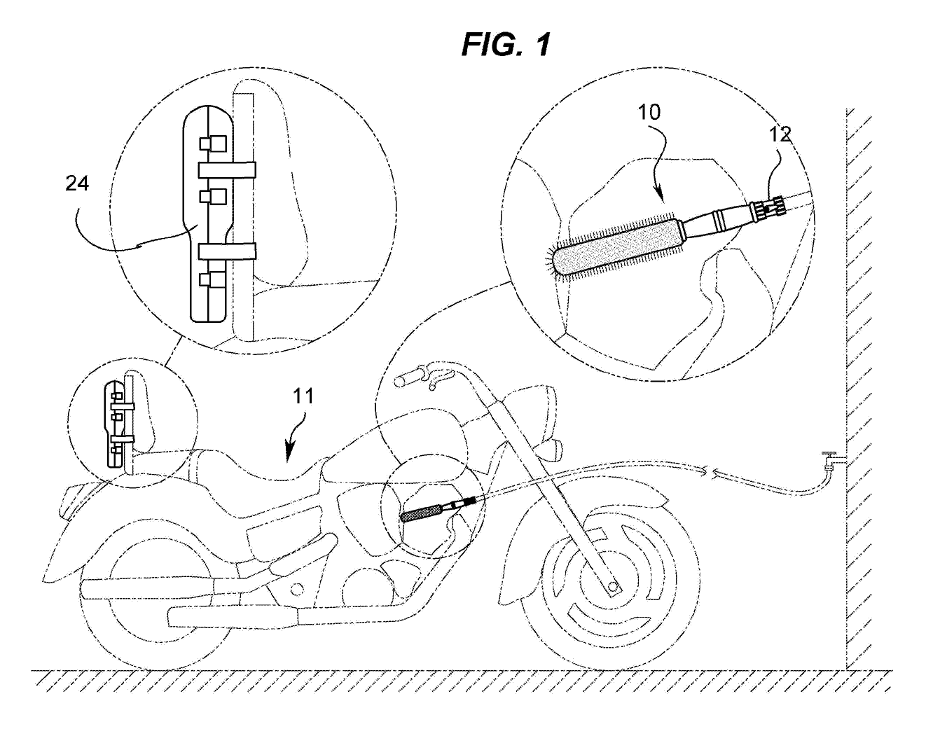

FIG. 2 Cutaway side view of the invention.

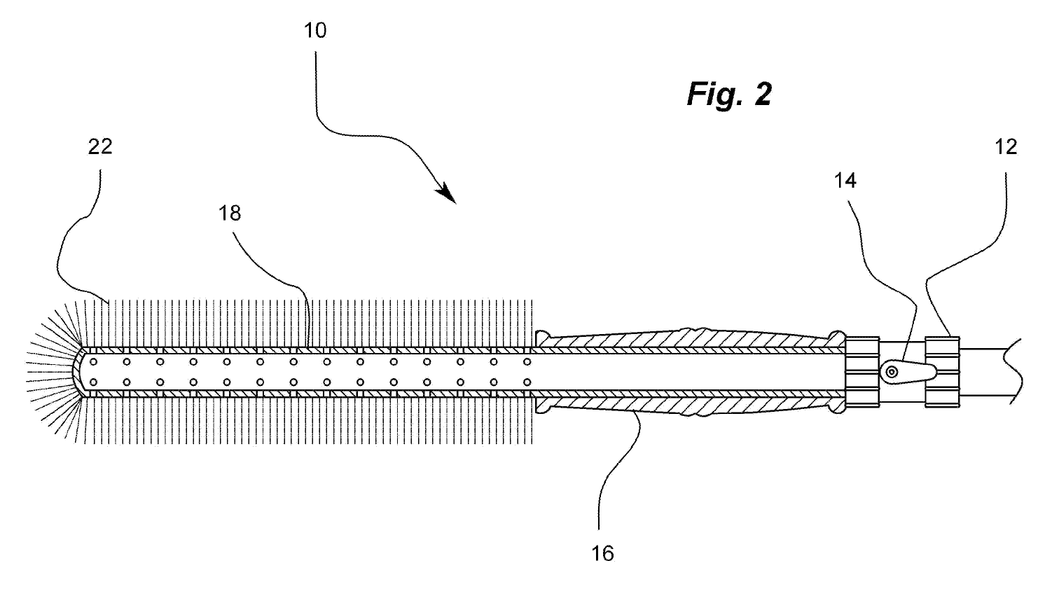

FIGS. 3a-c Side views of variations of the invention.

### DETAILED DESCRIPTION OF THE PREFERRED EMBODIMENT

A cleaning brush (10) for use on a motorcycle (11) has a hose connector (12), a water shut off knob (14), a handle (16), a core member (18) through which water passes and holes (20) along the core member (18) so that water can exit. Bristles (22) are attached and extend from the core member (18).

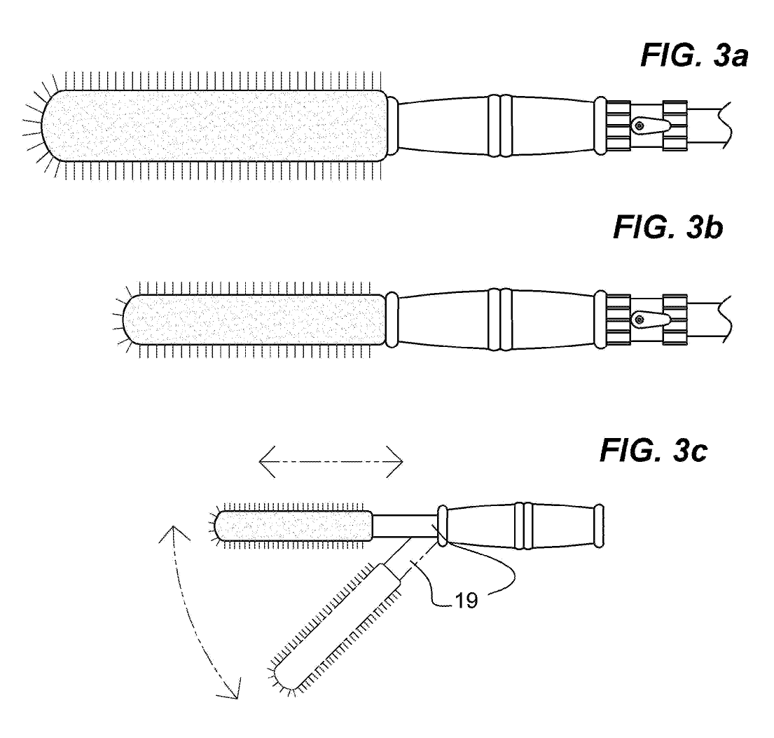

As can be seen in FIG. 3c, the core member (18) can protract and retract, as the case may be, by way of two telescoping members (19) and is therefore capable of protracting and retracting so as to better reach certain harder to reach areas. Moreover, an axial joint (not shown) allows for the core member (18) to bend along one axis so as to reach tight spaces.

A container (24), installed on the motorcycle (11), allows for the efficient stowaway of the cleaning brush (10).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1.) A cleaning brush for motorcycles comprising an elongated hollow core member adapted to allow water to pass therethrough, said core member including holes adapted to allow said water to pass therethrough and out from said hollow core member; a hose connector member located at a primary distal end of said core member, said hose connector member adapted to securely and removably connect to a hose member; a water shut-off valve member located upon said core member and adjacent said hose connector member, said water shut-off valve member adapted to block the flow of water through said core member when desired; a handle member located adjacent said water shut-off valve, said handle member adapted and shaped to increase the ease of handling said cleaning brush; and bristle members attached to an outer surface of said core member opposite said primary distal end, such that water can pass through said holes in said core member and onto, between, and through said bristles allowing the brush to be used to clean a motorcycle in a continuous and effective manner.

2.) The cleaning brush of claim 1, wherein said core member is cylindrical.

3.) The cleaning brush of claim 1, wherein said core member is adjustable in length.

4.) The cleaning brush of claim 3, wherein said core member is formed from two telescoping members and is therefore capable of protracting and retracting.

5) The cleaning brush of claim 1, wherein said core member is bendable along one axis.

6.) The cleaning brush of claim 1, wherein said water shut-off valve member includes a rotatable handle member, such that water can be blocked from passing through said core member by rotating said handle.

7.) A combination of a motorcycle and a cleaning brush, said motorcycle including a container member adapted to hold and store said cleaning brush when not in use; said cleaning brush comprising an elongated hollow core member adapted to allow water to pass therethrough, said core member including holes adapted to allow said water to pass therethrough and out from said hollow core member; a hose connector member located at a primary distal end of said core member, said hose connector member adapted to securely and removably connect to a hose member; a water shut-off valve member located upon said core member and adjacent said hose connector member, said water shut-off valve member adapted to block the flow of water through said core member when desired; a handle member located adjacent said water shut-off valve, said handle member adapted and shaped to increase the ease of handling said cleaning brush; and bristle members attached to an outer surface of said core member opposite said primary distal end, such that water can pass through said holes in said core member and onto, between, and through said bristles allowing the brush to be used to clean a motorcycle in a continuous and effective manner.

8.) The cleaning brush of claim 7, wherein said core member is cylindrical.

9.) The cleaning brush of claim 7, wherein said core member is adjustable in length.

10.) The cleaning brush of claim 9, wherein said core member is formed from two telescoping members and is therefore capable of protracting and retracting.

11) The cleaning brush of claim 6, wherein said core member is bendable along one axis.

12.) The cleaning brush of claim 6, wherein said water shut-off valve member includes a rotatable handle member, such that water can be blocked from passing through said core member by rotating said handle.
